(19) United States
(12) Patent Application Publication
(10) Pub. No.: US 2025/0004295 A1
(43) Pub. Date: Jan. 2, 2025

(54) DISPLAY DEVICE

(71) Applicant: Panasonic Automotive Systems Co., Ltd., Kanagawa (JP)

(72) Inventor: Toshiya MORI, Osaka Fu (JP)

(73) Assignee: Panasonic Automotive Systems Co., Ltd., Kanagawa (JP)

(21) Appl. No.: 18/755,278

(22) Filed: Jun. 26, 2024

(30) Foreign Application Priority Data
Jun. 30, 2023 (JP) 2023-108563

(51) Int. Cl. G02B 30/33; G02B 5/32

(52) U.S. Cl. CPC G02B 30/33; G02B 5/32

(57) ABSTRACT

A display device includes an image light emitter, a light guide body, and a processor. The image light emitter emits image light beams of a left-eye image and a right-eye image. The light guide body has an emission surface from which light incident from the image light emitter is emitted. The processor is configured to control the image light emitter. The light guide body includes a holographic element, and a light guide portion enclosing the holographic element. The image light beams emitted from the image light emitter are incident on the holographic element. The processor is configured to: identify positions of both eyes of a user based on a captured image of an imager that captures both eyes of the user; and adjust positions where the image light beams are incident on the holographic element according to the positions of the both eyes of the user.

### CROSS-REFERENCE TO RELATED APPLICATIONS

This application is based upon and claims the benefit of priority from Japanese Patent Application No. 2023-108563, filed on Jun. 30, 2023, the entire contents of which are incorporated herein by reference.

### FIELD

The present disclosure relates to a display device.

### BACKGROUND

Conventionally, there is known a technique of displaying a three-dimensional virtual image by emitting a right-eye image and a left-eye image having parallax with each other via a light guide plate.

A related technique is disclosed in US 2021/0294101 A.

However, in the related art, a right-eye waveguide is installed at a position corresponding to the right eye, and a left-eye waveguide is installed at a position corresponding to the left eye. Therefore, in a case where the position of the user's eye changes to either the left or right across the center, the right eye and the left eye are located at positions corresponding to the right-eye waveguide, or the left eye and the right eye are located at positions corresponding to the left-eye waveguide, and there is an issue that a three-dimensional virtual image cannot be appropriately displayed.

An object of the present disclosure is to provide a display device capable of appropriately displaying a three-dimensional virtual image even when a position of a user's eyes change.

### SUMMARY

According to the present disclosure, a display device includes an image light emitter, a light guide body, a memory and a processor. The image light emitter emits image light beams of a left-eye image and a right-eye image. The light guide body has an emission surface from which light incident from the image light emitter is emitted. The processor is coupled to the memory and configured to control the image light emitter. The light guide body includes a holographic element, and a light guide portion. The image light beams emitted from the image light emitter are incident on the holographic element. The light guide portion encloses the holographic element. The processor is configured to: identify positions of both eyes of a user based on a captured image of an imager that captures both eyes of the user; and adjust positions where the image light beams are incident on the holographic element according to the positions of the both eyes of the user.

### BRIEF DESCRIPTION OF THE DRAWINGS

FIG. 1 is a diagram illustrating an example of a schematic configuration of a display device according to an embodiment;

FIG. 2 is a diagram illustrating an example of a configuration of a holographic element according to the embodiment;

FIG. 3 is a diagram illustrating an example of a hardware configuration of a control unit according to the embodiment;

FIG. 4 is a diagram illustrating an example of functions of a control unit according to the embodiment;

FIG. 5 is a schematic diagram for explaining control by the control unit according to the embodiment;

FIG. 6 is a schematic diagram for explaining control by the control unit according to a modification;

FIG. 7 is a diagram for explaining a propagation distance;

FIGS. 8A to 8c are diagrams illustrating a relationship between a pupillary distance and a propagation distance;

FIG. 9 is a schematic diagram for explaining a mode in which a mirror coat is disposed on a light guide portion;

FIG. 10 is a schematic diagram for explaining control by a control unit according to a modification;

FIG. 11 is a diagram for explaining a principle of a mode in which an emission angle is changed according to viewing usage;

FIG. 12A to 12C are diagrams for explaining a mode in which an emission angle is changed according to viewing usage; and

FIG. 13 is a diagram for explaining a principle of a mode in which an emission image at a turning position of the turning holographic element corresponding to the position of the user's eye and an emission image at a turning position adjacent to the aforementioned turning position are continuously emitted on an emission surface of an emission holographic element.

### DETAILED DESCRIPTION

Hereinafter, a display device according to an embodiment of the present disclosure will be described in detail with reference to the accompanying drawings.

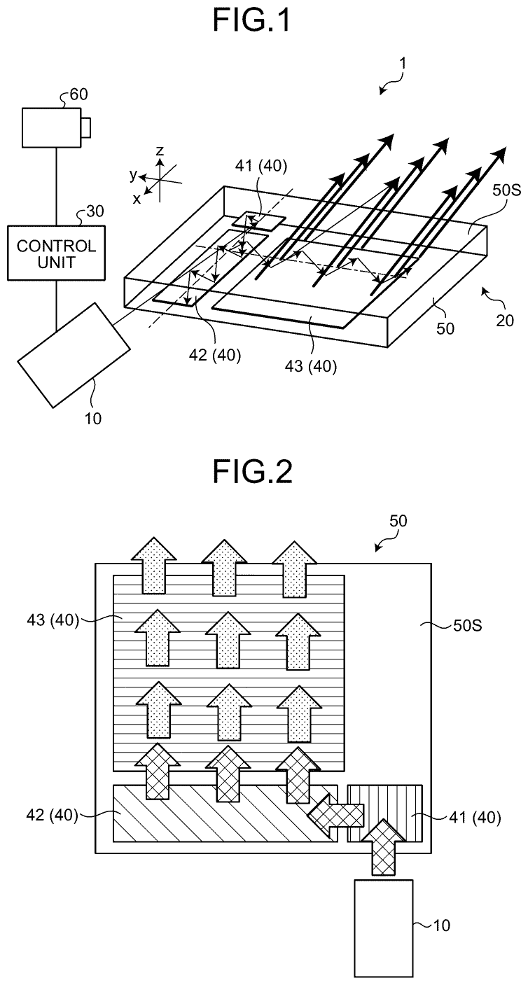

FIG. 1 is a diagram illustrating an example of a schematic configuration of a display device 1 according to the present embodiment.

As illustrated in FIG. 1, the display device 1 includes an image light emitting unit 10, a light guide body 20, and a control unit 30.

The display device 1 is a light guide plate type hologram display, and projects a right-eye image and a left-eye image emitted from the image light emitting unit 10 via the light guide body 20 to display a three-dimensional virtual image. For example, by disposing the display device 1 on a dashboard of a vehicle, the display device 1 can also be used as a light-guide plate type hologram HUD (head-up display). Hereinafter, a specific configuration of the display device 1 will be described.

The image light emitting unit 10 emits image light beams of a left-eye image (two-dimensional image) and a right-eye image (two-dimensional image). For example, the image light emitting unit 10 includes a small display device that displays a left-eye image and a right-eye image.

The light guide body 20 has an emission surface that emits the image light beams incident from the image light emitting unit 10. The image light beams emitted from the emission surface are guided to both eyes of the user, and the user can visually recognize a three-dimensional virtual image. The light guide body 20 includes a holographic element 40 on which light emitted from the image light emitting unit 10 is incident and a light guide portion 50 enclosing the holographic element 40.

FIG. 2 is a diagram illustrating an example of a configuration of the holographic element 40 according to the present embodiment.

As illustrated in FIG. 2, the holographic element 40 includes an incident holographic element 41 on which the image light beams emitted from the image light emitting unit 10 are incident, a turning holographic element 42 on which the image light beams emitted from the incident holographic element 41 are incident, and an emission holographic element 43 on which the image light beams emitted from the turning holographic element 42 are incident and that emits them from an emission surface 50S of the light guide portion 50.

In this case, each of the incident holographic element 41, the turning holographic element 42, and the emission holographic element 43 is configured as a transmission diffractive optical element.

In the present embodiment, the case where the holographic element 40 includes three holographic elements is illustrated, but the present invention is not limited thereto. For example, the holographic element 40 may include two holographic elements. Specifically, the holographic element 40 may include at least two of the incident holographic element 41, the turning holographic element 42, and the emission holographic element 43.

In this case, when the holographic element 40 includes two holographic elements of the incident holographic element 41 and the turning holographic element 42, the turning holographic element 42 may have the function of the emission holographic element 43.

In addition, in a case where the holographic element 40 includes two holographic elements of the turning holographic element 42 and the emission holographic element 43, the turning holographic element 42 may have the function of the incident holographic element 41.

In addition, in a case where the holographic element 40 includes two holographic elements of the incident holographic element 41 and the emission holographic element 43, the incident holographic element may have the function of the turning holographic element 42.

In the example of FIG. 2, the image light beams emitted from the image light emitting unit 10 are incident on the incident holographic element 41, diffracted by the incident holographic element 41, and emitted toward the turning holographic element 42.

The image light beams incident on the turning holographic element 42 are diffracted while being expanded (enlarged) in a light propagation direction (x direction in the example of FIG. 2) in the turning holographic element 42, and are emitted toward the emission holographic element 43.

Further, the image light incident on the emission holographic element 43 is diffracted while being expanded (enlarged) in a light propagation direction (y direction in the example of FIG. 2) in the emission holographic element 43, and is emitted from the emission surface 50S of the light guide portion 50.

In addition, the light guide portion 50 of the present embodiment includes a pair of (two) glass plates facing each other, and the incident holographic element 41, the turning holographic element 42, and the emission holographic element 43 are sandwiched between the pair of glass plates.

Returning to FIG. 1, the description will be continued. The control unit 30 identifies the positions of the both eyes of the user (the positions of the pupils) on the basis of a captured image of an imaging unit 60 that captures images of the both eyes of the user, and adjusts the position where the image light beams enter the holographic element 40 according to the positions of the both eyes of the user. The imaging unit 60 is, for example, a visible light camera, an infrared camera, a TOF sensor, or the like.

More specifically, the control unit 30 determines the emission positions at which the image light beams from the emission holographic element 43 is emitted from the emission surface 50S of the light guide portion 50 on the basis of the positions of both eyes of the user. That is, the control unit 30 determines the emission position of the image light beam corresponding to the left-eye image so that the image light beam corresponding to the left-eye image is incident on the pupil of the left eye of the user, and determines the emission position of the image light beam corresponding to the right-eye image so that the image light beam corresponding to the right-eye image is incident on the pupil of the right eye of the user.

Then, the control unit 30 determines the turning positions at which the image light beams are emitted from the turning holographic element 42 on the basis of the emission positions of the image light beams from the emission surface 50S of the light guide portion 50.

Furthermore, the control unit 30 determines the incident positions where the image light beams are incident on the incident holographic element 41 on the basis of the turning positions for each of the image light beam corresponding to the left-eye image and the image light beam corresponding to the right-eye image.

Then, the control unit 30 performs adjustment so that the image light beams (the image light beam corresponding to the left-eye image and the image light beam corresponding to the right-eye image) emitted by the image light emitting unit 10 is incident on the determined incident position. Furthermore, the control unit 30 can adjust positions where the image light beams are incident on the holographic element 40 according to the positions of both eyes of the user and control the image light emitting unit 10 to change the left-eye image and the right-eye image. Hereinafter, a specific configuration of the control unit 30 will be described.

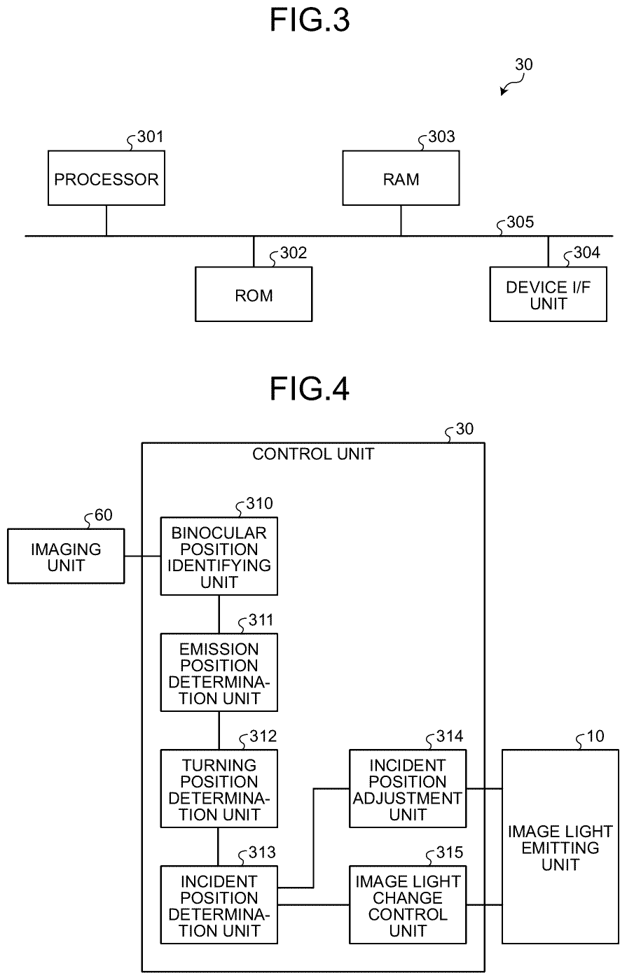

FIG. 3 is a diagram illustrating an example of a hardware configuration of the control unit 30.

In the present embodiment, the control unit 30 is configured as a so-called computer device.

As illustrated in FIG. 3, the control unit 30 includes a processor 301, a read only memory (ROM) 302, a random access memory (RAM) 303, a device interface (I/F) unit 304, and a bus 305. Note that the hardware components of the control unit 30 are not limited to the configuration illustrated in FIG. 3, and may have a form further including other hardware components.

The processor 301 is, for example, a central processing unit (CPU). The processor 301 executes the program to integrally control the operation of the control unit 30 and implement various functions of the control unit 30. Various functions of the control unit 30 will be described later.

The ROM 302 is a non-volatile memory, and stores various types of information including programs and the like executed by the processor 301.

The RAM 303 is a volatile memory having a work area of the processor 301.

The device I/F unit 304 is an interface for connecting to an external device (for example, the image light emitting unit 10, the imaging unit 60, and the like).

The bus 305 communicably connects the processor 301, the ROM 302, the RAM 303, and the device I/F unit 304.

FIG. 4 is a diagram illustrating an example of functions of the control unit 30. In the example of FIG. 4, only the functions necessary for describing the main part of the present embodiment are illustrated, but the functions of the control unit 30 are not limited thereto.

As illustrated in FIG. 4, the control unit 30 includes a binocular position identifying unit 310, an emission position determination unit 311, a turning position determination unit 312, an incident position determination unit 313, an incident position adjustment unit 314, and an image light change control unit 315. In the present embodiment, the processor 301 executes the program stored in the ROM 302 to implement the respective functions of the binocular position identifying unit 310, the emission position determination unit 311, the turning position determination unit 312, the incident position determination unit 313, the incident position adjustment unit 314, and the image light change control unit 315. However, the present invention is not limited thereto, and some or all of these functions may be realized by a dedicated hardware circuit (semiconductor integrated circuit or the like).

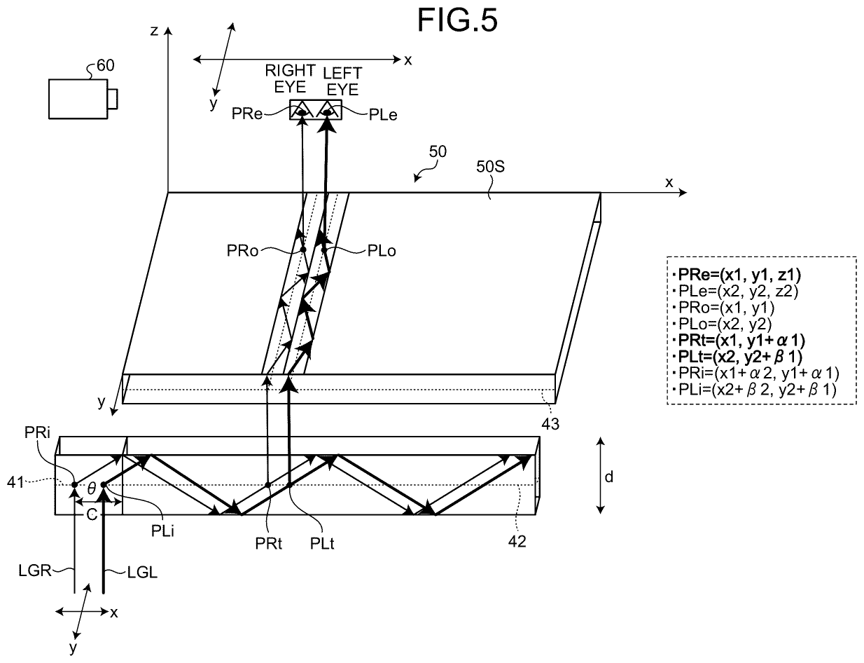

The binocular position identifying unit 310 identifies the positions of both eyes of the user based on the captured image captured by the imaging unit 60. More specifically, the binocular position identifying unit 310 measures coordinates of the pupil positions of the right eye and the left eye as right-eye coordinates PRe and left-eye coordinates PLe by eye tracking using the imaging unit 60. In the example of FIG. 5, it is assumed that the right-eye coordinates PRe=(x1, y1, z1) and the left-eye coordinates PLe=(x2, y2, z2).

The emission position determination unit 311 determines emission positions at which the image light beams are emitted from the emission holographic element 43 on the basis of the positions of both eyes of the user identified by the binocular position identifying unit 310.

FIG. 5 is a schematic diagram for explaining control by the control unit according to the embodiment.

In the example of FIG. 5, positions on the xy plane of the right-eye coordinates PRe and the left-eye coordinates PLe are set as emission positions, and it is assumed that the right-eye coordinates PRe and the left-eye coordinates PLe exist on an extension line extending from the emission position in the z-axis direction.

In the example of FIG. 5, it is assumed that the right-eye emission position PRo=(x1, y1) and the left-eye emission position PLo=(x2, y2). It is assumed that light is emitted from the right-eye emission position PRo toward the right-eye coordinates PRe, and light is emitted from the left-eye emission position PLo toward the left-eye coordinates PLe, so that the light reaches both eyes of the user.

The turning position determination unit 312 illustrated in FIG. 4 determines the turning positions (the right-eye turning position PRt and the left-eye turning position PLt) at which the image light beams are emitted from the turning holographic element 42 on the basis of the emission position (the right-eye emission position PRo and the eye emission position PLo) determined by the emission position determination unit 311.

In the example of FIG. 5, it is assumed that the light emitted from the right-eye turning position of the turning holographic element 42 to the emission holographic element 43 reaches the right-eye emission position PRo while repeating total reflection inside the light guide portion 50.

In addition, it is assumed that the light emitted from the left-eye turning position of the turning holographic element 42 to the emission holographic element 43 passes through the emission holographic element 43 inside the light guide portion 50 and reaches the left-eye emission position PLo of the emission holographic element 43 while repeating total reflection.

That is, the right-eye emission position PRo=(x1, y1) is a position where the light emitted from the right-eye turning position PRt of the turning holographic element 42 to the emission holographic element 43 reaches the emission holographic element 43 by repeating total reflection in the light propagation direction (y direction).

Here, the right-eye turning position PRt=(x1, y1+α1) can be expressed. α1 is a distance corresponding to the number of total reflection (in the example of FIG. 5, four times) of the right-eye image light beam from the emission of the turning holographic element 42 to the right-eye turning position PRt.

Similarly, the left-eye emission position PLo=(x2, y2) is a position where the light emitted from the left-eye turning position PLt of the turning holographic element 42 to the emission holographic element 43 is reached by repeating total reflection in the light propagation direction (y direction).

Here, the left-eye turning position PLt=(x2, y2+β1) can be expressed. β1 is a distance corresponding to the number of total reflection (in the example of FIG. 5, four times) of the left-eye image light beam from the emission of the turning holographic element 42 to the left-eye turning position PLt.

The incident position determination unit 313 illustrated in FIG. 4 determines incident positions where the image light beams enters the incident holographic element 41 on the basis of the turning positions determined by the turning position determination unit 312.

In the example of FIG. 5, it is assumed that the light emitted from the right-eye incident position PRi of the incident holographic element 41 to the turning holographic element 42 reaches the right-eye turning position PRt while repeating total reflection inside the light guide portion 50. In addition, it is assumed that the light emitted from the left-eye incident position of the incident holographic element 41 to the turning holographic element 42 reaches the left-eye turning position PLt while repeating total reflection inside the light guide portion 50.

That is, the right-eye turning position PRt=(x1, y1+α1) is a position at which the light emitted from the right-eye incident position PRi of the incident holographic element 41 to the turning holographic element 42 reaches by repeating total reflection in the light propagation direction (x direction), and can be expressed as a right-eye incident position PRi=(x1+α2, y1+α1). Here, α2 is a distance corresponding to the number of total reflection (in the example of FIG. 5, two times) of the right-eye image light beam from the emission of the incident holographic element 41 to the right-eye turning position PRt.

Similarly, the left-eye turning position PLt=(x2, y2+β1) is a position at which the light emitted from the left-eye incident position of the incident holographic element 41 to the turning holographic element 42 reaches by repeating total reflection in the light propagation direction (x direction), and can be expressed as a left-eye incident position PLi=(x2+β2, y2+β1). Here, β2 is a distance corresponding to the number of total reflection (in the example of FIG. 5, two times) of the left-eye image light beam from the emission of the incident holographic element 41 to the left-eye turning position PLt.

Here, if the thickness of the light guide portion 50 (size in the z direction in the example of FIG. 5) is d and the diffraction angle of the incident holographic element 41 is θ, the incident condition of light on the incident holographic element 41 is expressed by the following Formula 1.

$$d / 2 = {d}^{′} , c = {d}^{′} / tan θ \qquad ( Formula 1 )$$

Based on the above-described incident condition, it can be considered that a position shifted in the x direction by c×4×n (n: natural number) from the right-eye incident position PRi is the right-eye turning position PRt (α2=−c×4×n).

Similarly, it can be considered that a position shifted in the x direction by c×4×n from the left-eye incident position PLi becomes the left-eye turning position PLt (β2=−c×4×n). Note that, in a case where n cannot be expressed as a natural number, the right-eye incident position PRi and the left-eye incident position PLi may be adjusted so as to be a natural number.

Returning to FIG. 4, the description will be continued. The incident position adjustment unit 314 performs adjustment such that the image light beams emitted by the image light emitting unit 10 are incident on the incident positions PRi and PLi determined by the incident position determination unit 313.

As this adjustment method, various methods can be used. For example, in a case where the image light emitting unit 10 is a small display device, the incident positions of the image light beams on the incident holographic element 41 can be adjusted by changing the display positions of the right-eye image and the left-eye image displayed on the small display device. Furthermore, for example, the incident positions of the image light beams on the incident holographic element 41 can be adjusted by moving the small display device without changing the display position of the image on the small display device.

Furthermore, the image light emitting unit 10 may be, for example, a projector such as a liquid crystal on silicon (LCOS) using a laser light source, and can also adjust the emission directions of the image light beams so that the image light beams emitted from the projector enter the incident positions PRi and PLi of the incident holographic element 41. Furthermore, the image light emitting unit 10 may be in a mode of generating a right-eye image and a left-eye image using, for example, a computer-generated hologram (CGH) technology, and can adjust the emission directions of the image light beams so that the image light beams generated using the CGH are incident on the incident positions of the incident holographic element 41.

The image light change control unit 315 controls the image light emitting unit 10 to change the left-eye image and the right-eye image according to the positions of both eyes of the user identified by the binocular position identifying unit 310. For example, the image light change control unit 315 may not be provided.

As described above, the display device 1 of the present embodiment adjusts the positions where the image light beams are incident on the holographic element 40 such that the image light beams emitted from the image light emitting unit 10 are guided to both eyes according to the positions of both eyes of the user, and thus, it is possible to appropriately display a three-dimensional virtual image even if the positions of both eyes of the user change.

Although embodiments of the present disclosure have been described above, these embodiments described above have been presented as examples, and are not intended to limit the scope of the invention. These novel embodiments can be implemented in various other forms, and various omissions, substitutions, and changes can be made without departing from the gist of the invention. These novel embodiments and modifications thereof are included in the scope and gist of the invention and are included in the invention described in the claims and the equivalent scope thereof.

Furthermore, the effects of the embodiments described in the present specification are merely examples and are not limited, and other effects may be provided.

Hereinafter, modifications will be described.

### (1) First Modification

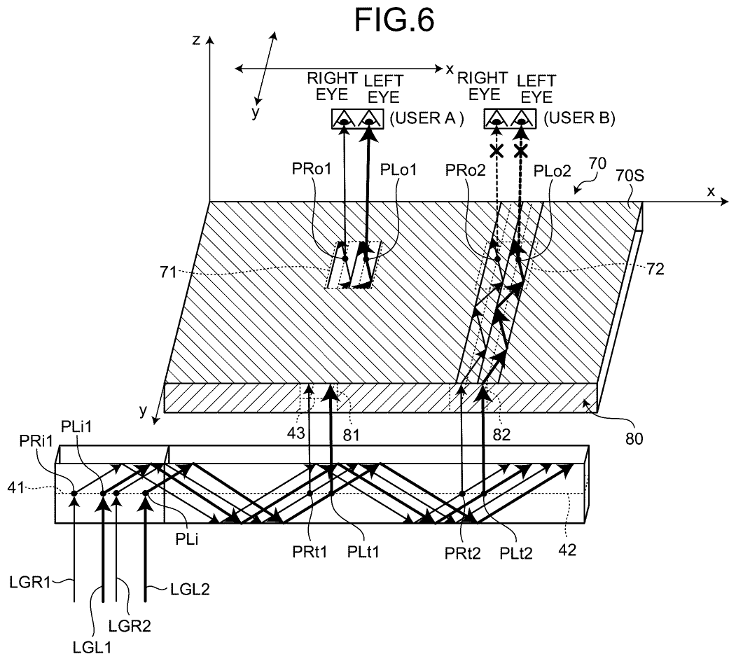

For example, as illustrated in FIG. 6, the light guide portion 50 may include a light shielding member 70 and a light shielding member 80.

The light shielding member 70 includes a plurality of regions 71 and 72 that can transition between a state where light is transmitted and a state where light. is blocked The region 71 corresponds to a user A (corresponds to both eyes of the user A), and the region 72 corresponds to a user B (corresponds to both eyes of the user B). The setting positions of these regions 71 and 72 can be changed according to the positions of the corresponding user's eyes.

The light shielding member 70 is disposed on the emission surface side of the emission holographic element 43.

Similarly, the light shielding member 80 also includes a plurality of regions 81 and 82 that can transition between a state where light is transmitted and a state where light is blocked. The region 81 corresponds to the user A (corresponds to both eyes of the user A), and the region 82 corresponds to the user B (corresponds to both eyes of the user B). The light shielding member 80 is disposed between the turning holographic element 42 and the emission holographic element 43.

In the form of FIG. 6, the control unit 30 controls the light shielding member 70 so that a plurality of regions 71 and 72 on the light shielding member 70 corresponding to a plurality of users on a one-to-one basis are in a state where light is transmitted in a time division manner. More specifically, in a case where the user A is caused to visually recognize a three-dimensional virtual image, the control unit 30 controls the light shielding member 70 so that the region 71 corresponding to the user A on the light shielding member 70 transmits light and the region 72 corresponding to the user B does not transmit light, and controls the image light emitting unit 10 so as to emit a right-eye image and a left-eye image according to the positions of both eyes of the user A. On the other hand, in a case where the user B is caused to visually recognize a three-dimensional virtual image, the control unit 30 controls the light shielding member 70 so that the region 72 corresponding to the user B on the light shielding member 70 transmits light and the region 71 corresponding to the user A does not transmit light, and controls the image light emitting unit 10 so as to emit a right-eye image and a left-eye image according to the positions of both eyes of the user B.

Similarly, in the form of FIG. 6, the control unit 30 controls the light shielding member 80 so that a plurality of regions 81 and 82 on the light shielding member 80 corresponding to a plurality of users on a one-to-one basis are in a state where light is transmitted in a time division manner. More specifically, in a case where the user A is caused to visually recognize a three-dimensional virtual image, the control unit 30 controls the light shielding member 80 so that the region 81 corresponding to the user A on the light shielding member 80 transmits light and the region 82 corresponding to the user B does not transmit light, and controls the image light emitting unit 10 so as to emit a right-eye image and a left-eye image according to the positions of both eyes of the user A. On the other hand, in a case where the user B is caused to visually recognize a three-dimensional virtual image, the control unit 30 controls the light shielding member 80 so that the region 82 corresponding to the user B on the light shielding member 80 transmits light and the region 81 corresponding to the user A does not transmit light, and controls the image light emitting unit 10 so as to emit a right-eye image and a left-eye image according to the positions of both eyes of the user B.

As described above, the control unit 30 controls the light shielding member so that a plurality of regions on the light shielding member corresponding to a plurality of users on a one-to-one basis are in a state where light is transmitted in a time division manner, and controls the image light emitting unit 10 so that image light beams for each user (image light according to the positions of both eyes of the user) are also emitted in a time division manner, whereby it is possible to prevent crosstalk in which an image of the other eye enters one eye.

### (2) Second Modification

In the incident holographic element 41, the size of an incident region (incident surface) indicating areas where image light beams are incident are desirably at least equal to or larger than the sizes of the right eye and the left eye. This is because when the size of the incident surface is smaller than the sizes of the right eye and the left eye, a plurality of image light beams enter the pupil, and crosstalk may occur.

### (3) Third Modification

For example, a propagation distance indicating an interval of the image light beams emitted from the emission surface of the light guide portion 50 may be set to a value at which crosstalk does not occur according to a pupillary distance indicating a distance between a pupil of a right eye and a pupil of a left eye of a user.

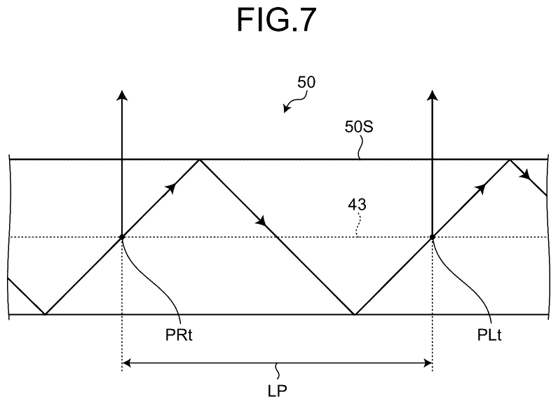

FIG. 7 is a diagram for explaining the propagation distance.

For example, as illustrated in FIG. 7, a propagation distance LP can be considered as an interval in a propagation direction (a direction in which total reflection is repeated inside the light guide portion 50) between the image light beams diffracted by the emission holographic element 43 and emitted from the emission surface.

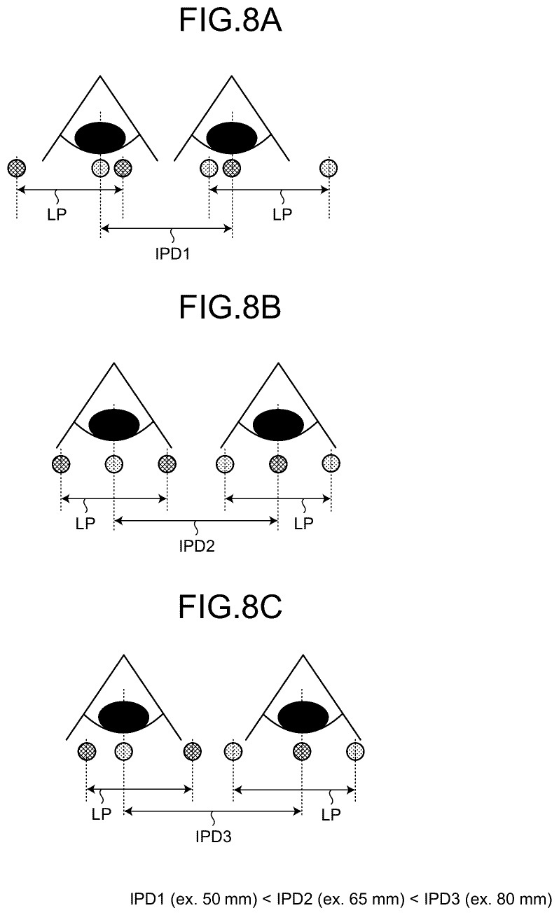

FIGS. 8A to 8C are diagrams illustrating a relationship between the pupillary distance and the propagation distance.

For example, in a case where the pupillary distance is assumed to be 60 to 70 mm, the propagation distance is set to a value larger than 35 mm and smaller than 60 mm.

Further, in a case where the pupillary distance is assumed to be 50 to 80 mm, the propagation distance is set to a value larger than 40 mm and smaller than 50 mm.

FIG. 8A illustrates an example of a case where the pupillary distance IPD1=50 mm, FIG. 8B illustrates an example of a case where the pupillary distance IPD2=65 mm, and FIG. 8C illustrates an example of a case where the pupillary distance IPD3=80 mm.

Here, the propagation distance LP is determined according to thickness d of the light guide portion 50. More specifically, in the light guide portions 50 of the same material having the same critical angle of total reflection, the propagation distance LP becomes shorter as the thickness d of the light guide portion 50 is smaller, and the propagation distance LP becomes longer as the thickness d of the light guide portion 50 is larger.

Therefore, since the pupillary distance is generally said to be 60 to 70 mm, the occurrence of crosstalk can be suppressed by setting the propagation distance LP to a value larger than 35 mm and smaller than 60 mm as described above. In addition, in a case where the pupillary distance is assumed to be 50 to 80 mm on the assumption that the pupillary distance is less than 60 mm or more than 70 mm, the occurrence of crosstalk can be more reliably suppressed by setting the propagation distance LP to a value larger than 40 mm and smaller than 50 mm.

As described above, when the pupillary distance is 60 to 70 mm, the thickness d of the light guide portion 50 may be set such that the propagation distance LP becomes a value larger than 35 mm and smaller than 60 mm. In addition, when the pupillary distance is 50 to 80 mm, the thickness d of the light guide portion 50 may be set such that the propagation distance LP becomes a value larger than 40 mm and smaller than 50 mm. In other cases, similarly, the thickness of the light guide portion 50 is set to have a desired propagation distance.

### (4) Fourth Modification

For example, the light guide portion 50 may have a form to further include a reflection member disposed in a portion facing the incident holographic element 41 and the turning holographic element 42.

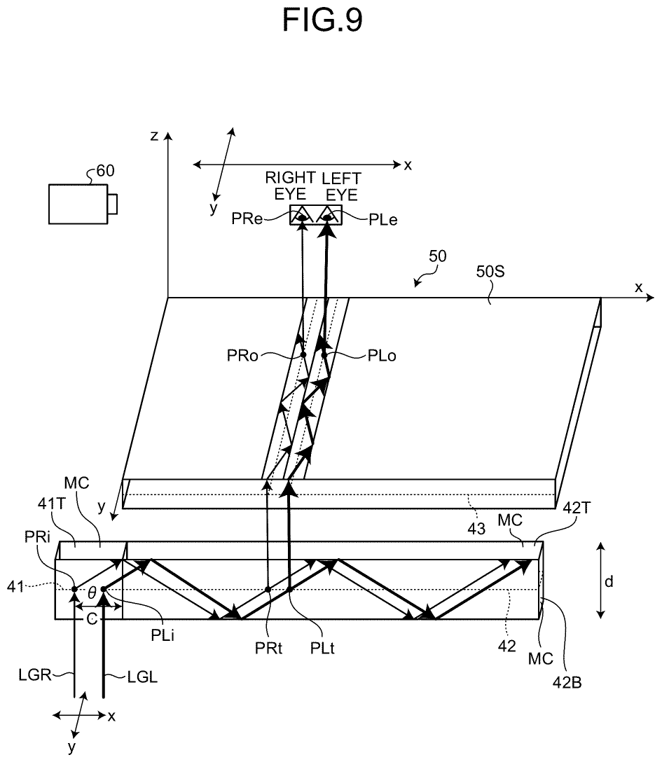

FIG. 9 is a schematic diagram for explaining a mode in which a mirror coat is disposed on a light guide portion.

For example, as illustrated in FIG. 9, the light guide portion 50 may have a form in which a mirror coat (an example of a “reflection member”) MC is disposed in a region on an emission surface side 41T of two regions facing the incident holographic element 41, and the mirror coat MC is disposed in each of two regions 42T and 42B (a region on the emission surface side and a region on the opposite side of the emission surface) facing the turning holographic element 42. In the above-described embodiment in which the mirror coat MC is not provided, the total reflection angle is assumed as the propagation angle of the image light beam in the portion of the light guide portion 50 where the incident holographic element 41 and the turning holographic element 42 are provided. However, by providing the mirror coat MC as described above, the propagation angle of the image light beam in the portion of the light guide portion 50 where the mirror coat is disposed can be set to an arbitrary angle other than the total reflection angle.

In this case, assuming that the propagation angle of the image light beam in the portion of the light guide portion 50 where the mirror coat is disposed is θ1 and the propagation angle of the image light beam in the portion of the light guide portion 50 where the mirror coat is not disposed is θ2 (=the propagation angle at the time of total reflection), for example, θ1>θ2 may be satisfied.

In other words, the any angle can be set without being affected by the value of the critical angle of total reflection of the light guide portion 50 at the portion where the mirror coat is not disposed.

### (5) Fifth Modification

For example, it is also possible to configure such that for the left-eye image light region and the right-eye image light region corresponding to the incident image light beams, the emission region is enlarged on the emission surface of the emission holographic element and emits in a state where it is rotated by a predetermined angle based on the eye movement frequency predicted according to the viewing usage.

JP 2011-180178 A discloses that image light beam is incident on a user at a steep angle and image light beam is incident at a shallow angle.

Based on this disclosure, the inventor has conceived a configuration in which the left-eye image light region and the right-eye image light region corresponding to the incident image light beams emit in a state where they are rotated by a predetermined angle on the emission surface of the emission holographic element based on the eye movement frequency predicted according to the viewing usage.

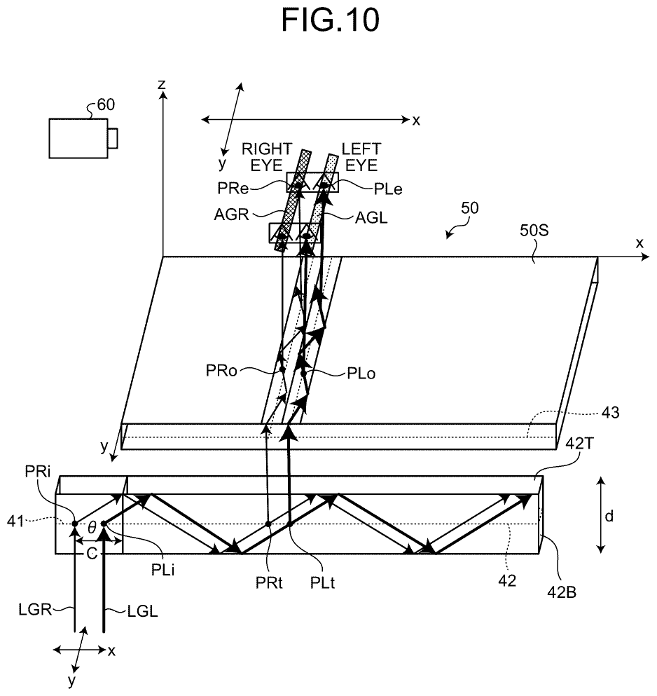

FIG. 10 is a schematic diagram for explaining control by a control unit according to the modification.

As illustrated in FIG. 10, the image light beams emitted from the emission holographic element 43 has a left-eye image light region AGL and a right-eye image light region AGR having a predetermined size on the emission surface 50S of the light guide body 20 (light guide portion 50). Specifically, when image light beams having predetermined sizes are incident on the incident holographic element 41 from the image light emitting unit 10, the left-eye image light region AGL and the right-eye image light region AGR are displayed in predetermined sizes on the emission surface 50S according to the predetermined size. In addition, by setting the predetermined size such that the left-eye image light region and the right-eye image light region having the predetermined size are continuously displayed with the left-eye image light region and the right-eye image light region formed by being emitted from the adjacent emission positions, the left-eye image light region AGL and the right-eye image light region AGR are enlarged on the emission surface 50S.

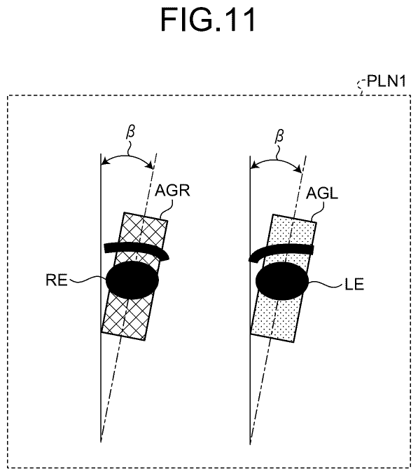

FIG. 11 is a diagram for explaining a principle of a mode in which an emission angle is changed according to viewing usage.

As illustrated in FIG. 11, in a case where it is assumed that a virtual plane PLN1 parallel to the emission surface 50S of the light guide portion 50 is disposed in front of the user's face, the emission holographic element 43 is configured to emit in a state where they are rotated by the predetermined angle β on the emission surface of the emission holographic element 43 so that the left-eye image light region AGL and the right-eye image light region AGR corresponding to the incident image light beams are in a state where they are rotated by a predetermined angle β.

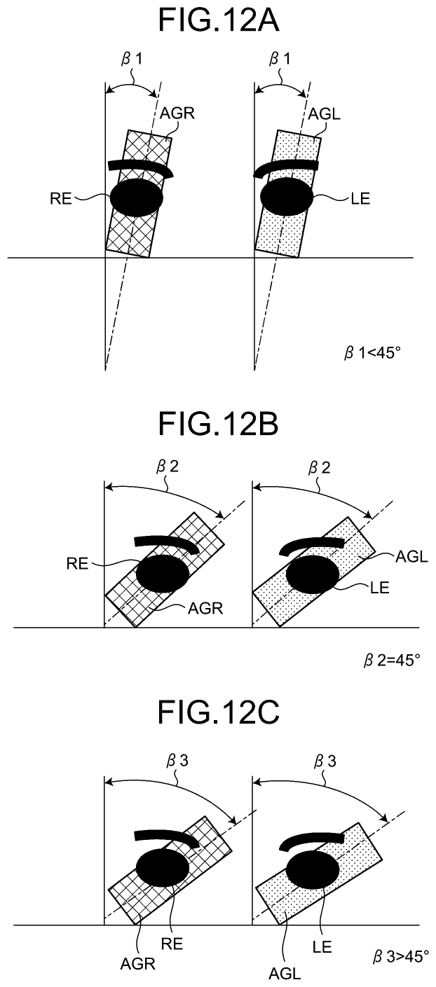

FIG. 12A to 12C are diagrams for explaining a mode in which an emission angle is changed according to viewing usage.

For example, in a case where the predicted eye movement frequency is larger in the vertical direction (y-direction when viewed from the emission surface 50S of the light guide body 20 (the light guide portion 50)) than in the horizontal direction (x-direction when viewed from the emission surface 50S of the light guide portion 50) as in the case of viewing a vertically long display, as illustrated in FIG. 12A, by setting the rotation angle β1 on the emission surface of the emission holographic element 43 to a value smaller than 45° (β1<) 45°, even if the eye moves in the vertical direction, the position of the pupil of the user hardly deviates from the corresponding image light regions AGL and AGR, and the control unit 30 can suppress the switching frequency of the left-eye image and the right-eye image.

Further, for example, in a case where the predicted movement frequency of eyes of the user is substantially equal in the vertical direction and in the horizontal direction, as illustrated in FIG. 12B, by setting a rotation angle β2=45° (or β2≈45°) on the emission surface of the emission holographic element 43, even if the eye moves in the vertical direction, the positions of the pupils of the user hardly deviate from the corresponding image light regions AGL and AGR, and the control unit 30 can suppress the switching frequency of the left-eye image and the right-eye image.

Furthermore, for example, in a case where the predicted movement frequency of eyes of the user is larger in the horizontal direction than in the vertical direction, as illustrated in FIG. 12C, by setting the rotation angle β1 to a value larger than 45° (β3>45°) on the emission surface of the emission holographic element 43, even if the eye moves in the horizontal direction, the positions of the pupils of the user hardly deviate from the corresponding image light regions AGL and AGR, and the control unit 30 can suppress the switching frequency of the left-eye image and the right-eye image.

### (6) Sixth Modification

In the above description, the emission images at one emission position PRo or PLo of the emission holographic element 43 corresponding to the position of the user's eyes have been described, but the same image is emitted from a plurality of emission positions of the emission holographic element 43.

Therefore, in the sixth modification, the emission holographic element 43 is formed to emit continuously an emission image at an emission position of the emission holographic element corresponding to the position of the user's eye and an emission image at an emission position adjacent to the aforementioned emission position on the emission surface 50S of the light guide body 20 (the light guide portion 50).

That is, for example, the size of the image light beam incident from the image light emitting unit 10 on the incident holographic element 41 is set such that the right-eye image light region formed by being emitted from the emission position of the emission holographic element 43 corresponding to the position of the user's right eye and another right-eye image light region formed by being emitted from the emission position adjacent to the emission position are continuously displayed.

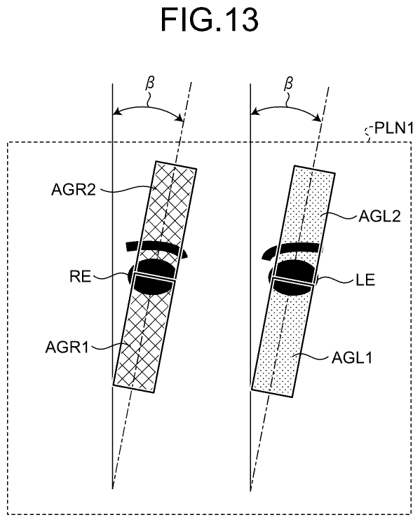

FIG. 13 is a diagram for explaining a principle of a mode in which an emission image at an emission position of the emission holographic element 43 corresponding to the position of the user's eye and an emission image at an emission position adjacent to the aforementioned emission position are continuously emitted on an emission surface 50S of the light guide body 20 (the light guide portion 50).

As illustrated in FIG. 13, in a case where it is assumed that the virtual plane PLN1 parallel to the emission surface 50S of the light guide body (light guide portion) is disposed in front of the face of the user, a right-eye image light region AGR1 corresponding to the emission image at the emission position of the emission holographic element corresponding to the position of the user's eye and a right-eye image light region AGR2 corresponding to the emission image at the emission position adjacent to the emission position of the emission holographic element corresponding to the position of the user's eye are continuously emitted on the emission surface of the light guide (light guide unit).

Therefore, this is effectively equivalent to expansion of the right-eye image light region AGR (=AGR1+AGR2), and the control unit 30 can suppress the switching frequency of the right-eye image.

Similarly, the left-eye image light region AGL1 corresponding to the emission image at the emission position of the emission holographic element corresponding to the position of the user's eye and the left-eye image light region AGL2 corresponding to the emission image at the emission position adjacent to the emission position of the emission holographic element corresponding to the position of the user's eye are continuously emitted on the emission surface of the light guide body (light guide portion), which is effectively equivalent to expansion of the left-eye image light region AGL (=AGL1+AGL2), and the control unit 30 can suppress the switching frequency of the left-eye image.

As a result, the positions of the pupils of the user hardly deviate from the corresponding left-eye image light region AGL and right-eye image light region AGR, and the control unit 30 can suppress the switching frequency of the left-eye image and the right-eye image.

In addition, similarly to the fifth modification, in a case where it is assumed that a virtual plane PLN1 parallel to the emission surface 50S of the light guide portion 50 is disposed in front of the user's face, the emission holographic element 43 may be configured to emit in a state where it is rotated by the predetermined angle β on the emission surface of the emission holographic element 43 so that the left-eye image light region AGL and the right-eye image light region AGR corresponding to the incident image light beams are in a state where they are rotated by a predetermined angle β.

According to this configuration, the effect of the fifth modification can be obtained in addition to the effect of the sixth modification.

### (7) Seventh Modification

In addition, in the above-described embodiment, an example has been described in which the incident holographic element 41, the turning holographic element 42, and the emission holographic element 43 are transmission type holograms that transmit and diffract light, but the incident holographic element 41, the turning holographic element 42, and the emission holographic element 43 can also be formed of reflection type holograms that reflect and diffract light.

The above-described embodiment can be arbitrarily combined with the above-described modifications, or the above-described modifications may be arbitrarily combined.

Furthermore, the display device 1 according to the above-described embodiment can also be used as a head mounted display, an eyeglass-type display, or the like.

### Supplement

The following technical aspects are disclosed by the above description of the embodiment.

### (First Aspect)

A display device including:
an image light emitting unit that emits image light beams of a left-eye image and a right-eye image;
a light guide body having an emission surface from which light incident from the image light emitting unit is emitted; and
a control unit configured to control the image light emitting unit, wherein
the light guide body includes:
   a holographic element on which the image light beams emitted from the image light emitting unit are incident; and
   a light guide portion enclosing the holographic element, and
the control unit is configured to:
   identify positions of both eyes of a user based on a captured image of an imaging unit that captures both eyes of the user; and
   adjust positions where the image light beams are incident on the holographic element according to the positions of the both eyes of the user.

### (Second Aspect)

The display device according to First Aspect, wherein
the control unit is configured to adjust positions where the image light beams are incident on the holographic element according to the positions of the both eyes of the user, and control the image light emitting unit to change the left-eye image and the right-eye image.

### (Third Aspect)

The display device according to First Aspect or Second Aspect, wherein
the holographic element includes an incident holographic element on which the image light beams are incident, a turning holographic element on which the image light beams emitted from the incident holographic element are incident, and an emission holographic element on which the image light beams emitted from the turning holographic element are incident and that emits the image light beams from the emission surface.

### (Fourth Aspect)

The display device according to Third Aspect, wherein
the control unit is configured to determine emission positions at which the image light beams are emitted from the emission holographic element based on positions of both eyes of the user, determine turning positions at which the image light beams are emitted from the turning holographic element based on the emission positions, and determine incident positions at which the image light beams are incident on the incident holographic element based on the turning positions.

### (Fifth Aspect)

The display device according to Fourth Aspect, wherein
the light guide portion includes a light shielding member having a plurality of regions each capable of transitioning between a state where light is transmitted and a state where light is blocked.

### (Sixth Aspect)

The display device according to Fifth Aspect, wherein
the light shielding member is disposed in at least one of a place facing the emission surface of the emission holographic element and a place between the turning holographic element and the emission holographic element.

### (Seventh Aspect)

The display device according to Fifth Aspect, wherein
the control unit is configured to:
   detect positions of both eyes of each of a plurality of users based on a captured image of an imaging unit that captures the both eyes of the plurality of users;
   determine emission positions at which the image light beams are emitted from the emission holographic element based on positions of both eyes of each of the plurality of users, determine turning positions at which the image light beams are emitted from the turning holographic element based on the emission positions, and determine positions at which the image light beams are incident on the incident holographic element based on the turning positions; and
control the light shielding member such that a plurality of regions on the light shielding member corresponding to the plurality of users on a one-to-one basis are in a state where light is transmitted in a time division manner.

### (Eighth Aspect)

The display device according to any one of First Aspect to Seventh Aspect, wherein
a propagation distance indicating an interval of the image light beams emitted from the emission surface is set to a value at which crosstalk does not occur according to a pupillary distance indicating a distance between a pupil of a right eye and a pupil of a left eye of the user.

### (Ninth Aspect)

The display device according to any one of First Aspect to Eight Aspect, wherein
a propagation distance indicating an interval of the image light beams emitted from the emission surface is set to a value larger than 35 mm and smaller than 60 mm.

### (Tenth Aspect)

The display device according to any one of Third Aspect, Fourth Aspect, and Sixth Aspect, wherein
the image light beams emitted from the emission holographic element have a left-eye image light region and a right-eye image light region, and
the emission holographic element enlarges the left-eye image light region and the right-eye image light region so that the left-eye image light region and the right-eye image light region are capable of absorbing movement of corresponding eyes in predetermined ranges, and emits the image light beams.

### (Eleventh Aspect)

The display device according to Tenth Aspect, wherein
the emission holographic element emits the image light beams such that emission images at emission positions of the emission holographic element corresponding to the positions of the eyes of the user and emission images at emission positions adjacent to the emission positions of the emission holographic element corresponding to the positions of the eyes of the user are continuously disposed on the emission surface of the light guide body.

### (Twelfth Aspect)

The display device according to any one of Third Aspect, Fourth Aspect, and Sixth Aspect, wherein
the image light beams emitted from the emission holographic element have a left-eye image light region and a right-eye image light region, and
the emission holographic element emits the image light beams in a state where the left-eye image light region and the right-eye image light region corresponding to the incident image light beams are inclined on the emission surface of the light guide body by a predetermined angle with respect to a direction orthogonal to a left-right direction of a mobile body on which the display device is mounted.

### (Thirteenth Aspect)

The display device according to Twelfth Aspect, wherein
the emission holographic element emits the image light beams such that emission images at emission positions of the emission holographic element corresponding to the positions of the eyes of the user and emission images at emission positions adjacent to the emission positions of the emission holographic element corresponding to the positions of the eyes of the user are continuously disposed on the emission surface of the light guide body.

### (Fourteenth Aspect)

The display device according to any one of Third Aspect, Fourth Aspect, and Sixth Aspect, wherein
the light guide portion further includes a reflection member disposed in a portion facing the incident holographic element and the turning holographic element.

### (Fifteenth Aspect)

The display device according to any one of Third Aspect, Fourth Aspect, and Sixth Aspect,
the incident holographic element, the turning holographic element, and the emission holographic element each include a transmission holographic element or a reflection holographic element.

According to the present disclosure, a three-dimensional virtual image can be appropriately displayed even when the positions of the user's eyes change. Note that the effects described herein are not necessarily limited, and may be any of the effects described in the present specification.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device comprising:
an image light emitter that emits image light beams of a left-eye image and a right-eye image;
a light guide body having an emission surface from which light incident from the image light emitter is emitted;
a memory; and
a processor coupled to the memory and configured to control the image light emitter, wherein
the light guide body includes:
a holographic element on which the image light beams emitted from the image light emitter are incident; and
a light guide portion enclosing the holographic element, and
the processor is configured to:
identify positions of both eyes of a user based on a captured image of an imager that captures both eyes of the user; and
adjust positions where the image light beams are incident on the holographic element according to the positions of the both eyes of the user.

2. The display device according to claim 1, wherein
the processor is configured to adjust positions where the image light beams are incident on the holographic element according to the positions of the both eyes of the user, and control the image light emitter to change the left-eye image and the right-eye image.

3. The display device according to claim 1, wherein
the holographic element includes an incident holographic element on which the image light beams are incident, a turning holographic element on which the image light beams emitted from the incident holographic element are incident, and an emission holographic element on which the image light beams emitted from the turning holographic element are incident and that emits the image light beams from the emission surface.

4. The display device according to claim 3, wherein
the processor is configured to determine emission positions at which the image light beams are emitted from the emission holographic element based on positions of both eyes of the user, determine turning positions at which the image light beams are emitted from the turning holographic element based on the emission positions, and determine incident positions at which the image light beams are incident on the incident holographic element based on the turning positions.

5. The display device according to claim 3, wherein
the light guide portion includes a light shielding member having a plurality of regions each capable of transitioning between a state where light is transmitted and a state where light is blocked.

6. The display device according to claim 5, wherein
the light shielding member is disposed in at least one of a place facing the emission surface of the emission holographic element and a place between the turning holographic element and the emission holographic element.

7. The display device according to claim 5, wherein
the processor is configured to:
detect positions of both eyes of each of a plurality of users based on a captured image of an imager that captures the both eyes of the plurality of users;
determine emission positions at which the image light beams are emitted from the emission holographic element based on positions of both eyes of each of the plurality of users, determine turning positions at which the image light beams are emitted from the turning holographic element based on the emission positions, and determine positions at which the image light beams are incident on the incident holographic element based on the turning positions; and
control the light shielding member such that a plurality of regions on the light shielding member corresponding to the plurality of users on a one-to-one basis are in a state where light is transmitted in a time division manner.

8. The display device according to claim 1, wherein
a propagation distance indicating an interval of the image light beams emitted from the emission surface is set to a value at which crosstalk does not occur according to a pupillary distance indicating a distance between a pupil of a right eye and a pupil of a left eye of the user.

9. The display device according to claim 1, wherein
a propagation distance indicating an interval of the image light beams emitted from the emission surface is set to a value larger than 35 mm and smaller than 60 mm.

10. The display device according to claim 3, wherein
the image light beams emitted from the emission holographic element have a left-eye image light region and a right-eye image light region, and
the emission holographic element enlarges the left-eye image light region and the right-eye image light region so that the left-eye image light region and the right-eye image light region are capable of absorbing movement of corresponding eyes in predetermined ranges, and emits the image light beams.

11. The display device according to claim 10, wherein
the emission holographic element emits the image light beams such that emission images at emission positions of the emission holographic element corresponding to the positions of the eyes of the user and emission images at emission positions adjacent to the emission positions of the emission holographic element corresponding to the positions of the eyes of the user are continuously disposed on the emission surface of the light guide body.

12. The display device according to claim 3, wherein
the image light beams emitted from the emission holographic element have a left-eye image light region and a right-eye image light region, and
the emission holographic element emits the image light beams in a state where the left-eye image light region and the right-eye image light region corresponding to the incident image light beams are inclined on the emission surface of the light guide body by a predetermined angle with respect to a direction orthogonal to a left-right direction of a mobile body on which the display device is mounted.

13. The display device according to claim 12, wherein
the emission holographic element emits the image light beams such that emission images at emission positions of the emission holographic element corresponding to the positions of the eyes of the user and emission images at emission positions adjacent to the emission positions of the emission holographic element corresponding to the positions of the eyes of the user are continuously disposed on the emission surface of the light guide body.

14. The display device according to claim 3, wherein
the light guide portion further includes a reflection member disposed in a portion facing the incident holographic element and the turning holographic element.
